(19) United States
(12) Patent Application Publication
(10) Pub. No.: US 2023/0221440 A1
(43) Pub. Date: Jul. 13, 2023

(54) SYNCHRONIZED BEAM SCANNING AND WAVELENGTH TUNING

(71) Applicant: BEIJING VOYAGER TECHNOLOGY CO., LTD., Beijing (CN)

(72) Inventors: An-Chun Tien, Mountain View, CA (US); Youmin Wang, Mountain View, CA (US)

(73) Assignee: BEIJING VOYAGER TECHNOLOGY CO., LTD., Beijing (CN)

(21) Appl. No.: 17/572,455

(22) Filed: Jan. 10, 2022

(51) Int. Cl. G01S 17/89; G01S 7/484; G01S 7/4863; G01S 7/481

(52) U.S. Cl. CPC G01S 17/89; G01S 7/484; G01S 7/4863; G01S 7/4817

(57) ABSTRACT

Embodiments of the disclosure provide an optical sensing system, and an optical sensing method for the optical sensing system. The optical sensing system includes an integrated optical source and a receiver coupled to the integrated optical source. The integrated optical source includes a laser diode configured to emit optical signals, and a first diffraction grating unit configured to simultaneously tune wavelengths and directions of the emitted optical signals. The optical signals of different wavelengths are directed along different directions towards an environment surrounding the optical sensing system. The receiver is configured to receive at least a portion of the optical signals returned from the environment. The receiver includes a second diffracting grating unit configured to direct the received portion of optical signals with the different wavelengths along different directions towards a sensor array. The sensor array is configured to receive the optical signals of the different wavelengths at different positions of the sensor array.

### TECHNICAL FIELD

The disclosure relates to a light detection and ranging (LiDAR) system, and more particularly to, a LiDAR system including a synchronized beam scanning and wavelength tuning for three-dimensional mapping.

### BACKGROUND

LiDAR is a remote sensing technology that measures the distance to an object by illuminating the target with a laser and then analyzing the reflected light. This allows the system to calculate the correct distances between objects. For a two-dimensional (2D) LiDAR system, only one laser beam is necessary, and a 2D sensor may employ a spin movement to collect data on X and Y axes. With the advancement of remote sensing technology, more applications begin to rely on 3D mapping to boost their performance. For instance, autonomous driving begins to rely on 3D environmental mapping to capture more accurate environmental information, so that a vehicle can navigate the environment predictably. Different from 2D mapping, in 3D mapping, data from X, Y, and Z axes all need to be collected. To achieve such data, most existing 3D LiDAR systems employ multiple laser beams that spread out on the vertical axes to obtain the X, Y, and Z-axis information, or combine LiDAR signal with signals captured by other sensors, such as cameras, to achieve a 3D mapping. This not only brings additional cost but also increases the complexity of the 3D LiDAR systems, due to the introduction of additional laser beams and/or cameras. For instance, the synchronization of signals from different LiDAR sensors and/or cameras requires extra efforts, such as signal alignment, data fusion, and so on.

Embodiments of the disclosure address the above problems by providing a scanning LiDAR system that employs a diffraction grating mechanism so that only a single laser diode is needed to acquire information for 3D mapping.

### SUMMARY

Embodiments of the disclosure provide an optical sensing system. The optical sensing system includes an integrated optical source and a receiver coupled to the integrated optical source. The integrated optical source includes a laser diode configured to emit optical signals, and a first diffraction grating unit configured to simultaneously tune wavelengths and directions of the emitted optical signals. The optical signals of different wavelengths are directed along different directions towards an environment surrounding the optical sensing system. The receiver is configured to receive at least a portion of the optical signals returned from the environment. The receiver includes a second diffracting grating unit configured to direct the received portion of optical signals with the different wavelengths along different directions towards a sensor array. The sensor array is configured to receive the optical signals of the different wavelengths at different positions of the sensor array.

Embodiments of the disclosure further provide an optical sensing method performed by an optical sensing system. The optical sensing method includes emitting, by a laser diode, optical signals. The method further includes tuning, by a first diffraction grating unit, wavelengths and directions of the optical signals towards an environment surrounding the optical sensing system. The method additionally includes receiving, by a second diffraction grating unit, a portion of the optical signals returned from the environment, where the received optical signals are diffracted towards different directions by the second diffraction grating unit. The method additionally includes receiving, by a sensor array, the diffracted optical signals with different wavelengths at different positions of the sensor array.

It is to be understood that both the foregoing general description and the following detailed description are exemplary and explanatory only and are not restrictive of the disclosure, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system including a Littrow configuration external cavity diode laser component, according to embodiments of the disclosure.

FIG. 3 illustrates a block diagram of an exemplary operation of a LiDAR system including a Littrow configuration external cavity diode laser component, according to embodiments of the disclosure.

FIG. 4A illustrates an example operation of a Littrow configuration external cavity diode laser component, according to embodiments of the disclosure.

FIG. 4B illustrates an example operation of another Littrow configuration external cavity diode laser component, according to embodiments of the present disclosure.

FIG. 5 illustrates an example 2D scanning pattern achieved by a Littrow configuration external cavity diode laser component, according to embodiments of the disclosure.

FIG. 6 illustrates an exemplary detection of returning laser beams with varying wavelengths by a detector containing a diffraction grating unit and a sensor array, according to embodiments of the disclosure.

FIG. 7 is a flow chart of an exemplary optical sensing method of a LiDAR system including a Littrow configuration external cavity diode laser component, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the disclosure provide an exemplary scanning LiDAR system that includes synchronized beam scanning and wavelength tuning for three-dimensional (3D) mapping. In the disclosed LiDAR system, a Littrow configuration external cavity diode laser component serves both as a tunable laser emitter and a 2D scanner, to allow a simultaneous sweeping of the wavelengths (e.g., emitted laser beams having varying wavelengths) while sweeping the beam points (e.g., emitted laser beams also having varying directions and thus sensing the objects at different angular positions). Accordingly, for laser beams returning from the environments, each laser beam has a specific wavelength and a directed towards an object in a corresponding angular direction in the environment. That is, the returning laser beams do not only contain distance information of a detected object, but also provide certain directional information of each detected point of the object in space, which thus provides an additional dimension of information for facilitating the construction of a 3D map of the scene of the interest.

In some embodiments, the Littrow configuration external cavity diode laser component in the disclosed LiDAR system includes a laser diode and a coupled resonator or external cavity, which also contains a diffraction grating unit. The external cavity may create an optical feedback loop in which a small amount of the diffracted laser (e.g., the 1^{st} order diffraction by the diffraction grating unit) is reflected back into laser diode 402. This optical feedback generated by the Littrow configuration creates the ability to provide slight adjustments to the wavelengths of the diode laser's output to match a desired set point. For instance, by slightly rotating the diffraction grating unit, the wavelength of the diode laser's output (which may be a 0^{th} order diffraction of the diffraction grating unit) can be also changed. Since the rotation of the diffraction grating unit also changes the direction of the diode laser's output, the wavelength and the beam pointing of a laser beam emitted by the Littrow configuration external cavity diode laser component can be simultaneously changed.

The laser beams emitted by the Littrow configuration external cavity diode laser component in the disclosed LiDAR system, when hitting an object in the environment, are both wavelength-specific and angular direction-specific in space with respect to the detected object. Therefore, a returning laser beam, when reflected by the detected object, contains both the wavelength information and the angular information of the detected point of the object. Accordingly, by determining the wavelength information of a returning laser beam, the angular information of the detected point of the object in space may be also obtained, which thus facilitates the construction of the 3D map by the disclosed LiDAR system.

In some embodiments, to facilitate the acquiring the wavelength information of a returning laser beam, the disclosed LiDAR system may further include a diffraction grating unit and a corresponding sensor array coupled to the diffraction grating unit in the receiving end. The receiving end diffraction grating unit may direct returning laser beams with different wavelengths towards different directions. The coupled sensor array may include a plurality of sensor units, where each sensor unit may cover diffracted laser beams from only a certain direction. Therefore, each sensor unit may cover only a laser beam(s) with a certain wavelength(s). By extracting the detected signal from a specific sensor unit at a specific moment during a scanning or environmental detection process, the wavelength of the detected signal can be easily identified, then the corresponding angular information for a detected object can be conveniently obtained, and be used for subsequent 3D map construction.

As can be seen, in the disclosed LiDAR system, a single laser diode is used for the construction of a 3D map, which not only reduces the cost but also the complexity of a LiDAR system, thereby simplifying the configuration and/or further data processing in the construction of a 3D map. Meanwhile, by introducing a diffraction grating unit and a sensor array in the receiving end, ambient light can be easily filtered out, since most ambient light may not have a wavelength that is diffracted to a specific sensor unit at a specific moment. This then further improves the accuracy in object detection by the disclosed LiDAR system. The features and advantages described herein are not all-inclusive and many additional features and advantages will be apparent to one of ordinary skill in the art in view of the figures and the following descriptions.

The disclosed LiDAR system containing a Littrow configuration external cavity diode laser component can be used in many applications including 3D mapping. For example, the disclosed LiDAR system can be used in advanced navigation technologies, such as to aid autonomous driving or to generate high-definition maps, in which the optical sensing system can be equipped on a vehicle.

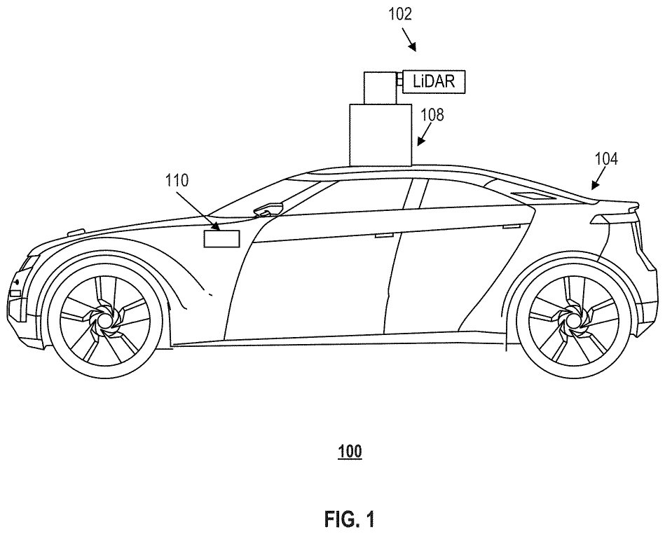

FIG. 1 illustrates a schematic diagram of an exemplary vehicle equipped with an optical sensing system, according to embodiments of the disclosure. Consistent with some embodiments, vehicle 100 may be a survey vehicle configured for acquiring data for constructing a high-definition map or three-dimensional (3D) buildings and city modeling. Vehicle 100 may also be an autonomous driving vehicle.

As illustrated in FIG. 1, vehicle 100 may be equipped with an optical sensing system, e.g., a LiDAR system 102 (also referred to as “LiDAR system 102” hereinafter) mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, the scanning system of LiDAR system 102 may be configured to scan the surrounding environment in a 2D scanning manner. LiDAR system 102 measures distance to a target by illuminating the target with laser beams and measuring the reflected/scattered pulses with a receiver. The laser beams used for LiDAR system 102 may be ultraviolet, visible, or near-infrared, and may be pulsed or continuous wave laser beams. In some embodiments of the present disclosure, LiDAR system 102 may capture point clouds including depth information of the objects in the surrounding environment, which may be used for constructing a high-definition map or 3D buildings and city modeling. As vehicle 100 moves along the trajectory, LiDAR system 102 may continuously capture data including the depth information of the surrounding objects (such as moving vehicles, buildings, road signs, pedestrians, etc.) for map, building, or city modeling construction.

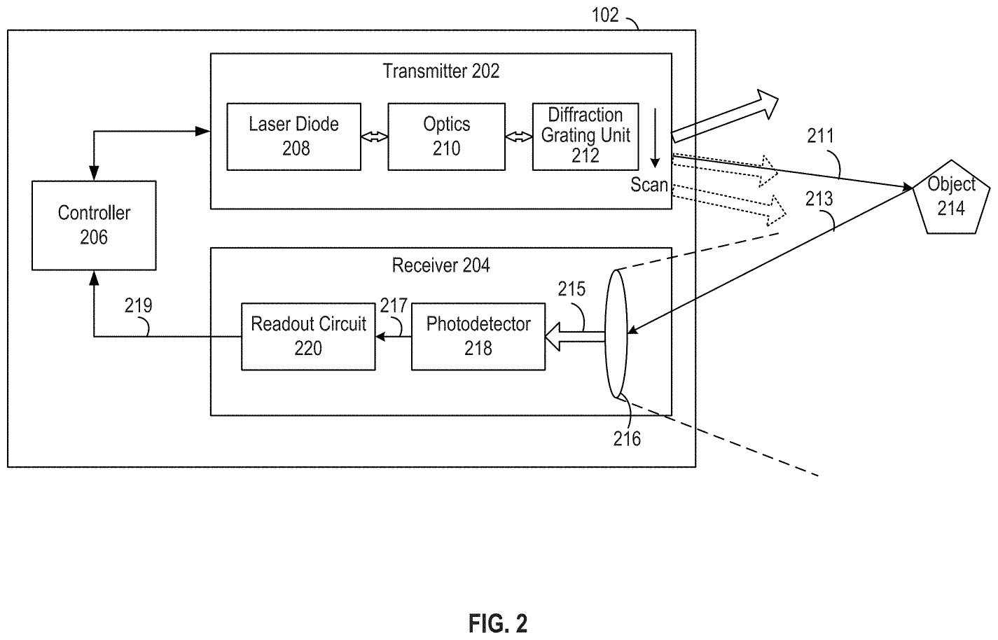

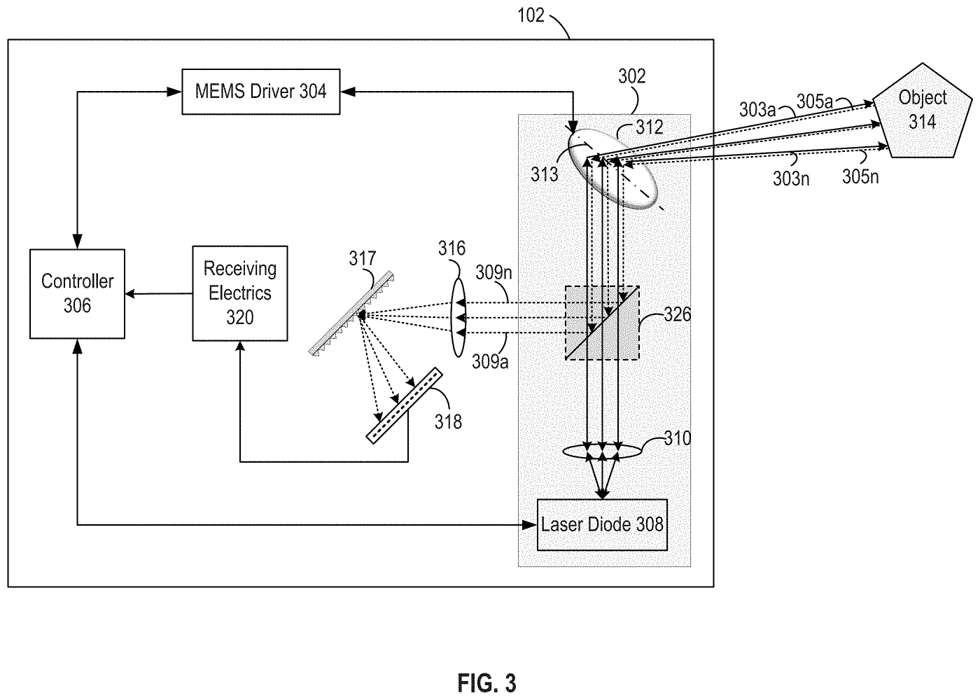

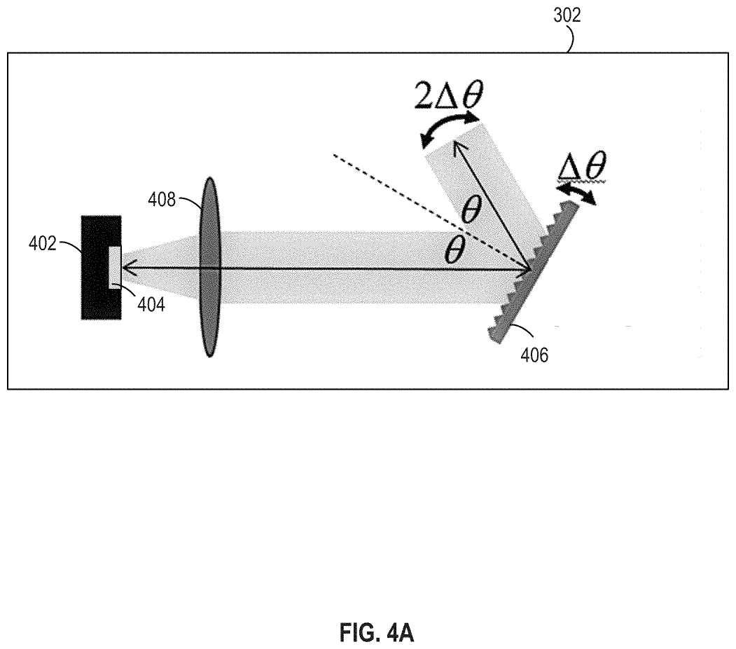

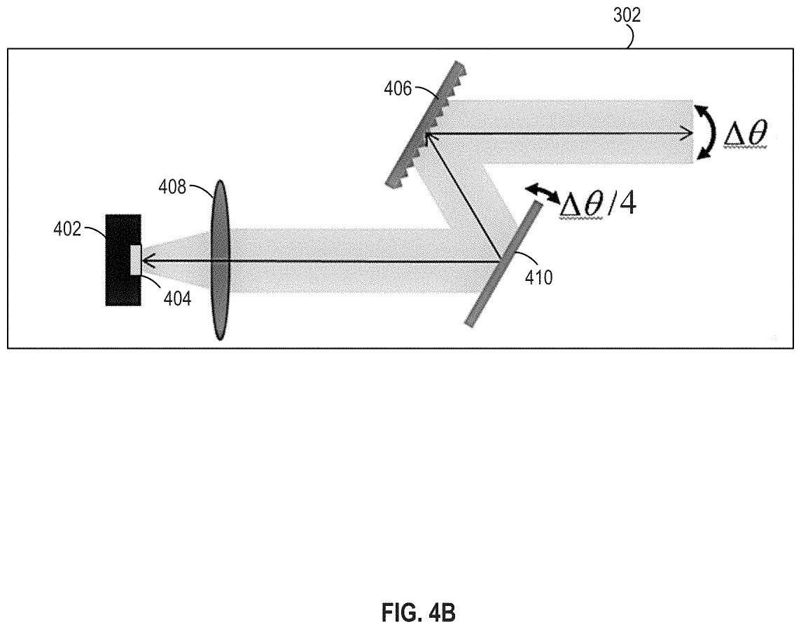

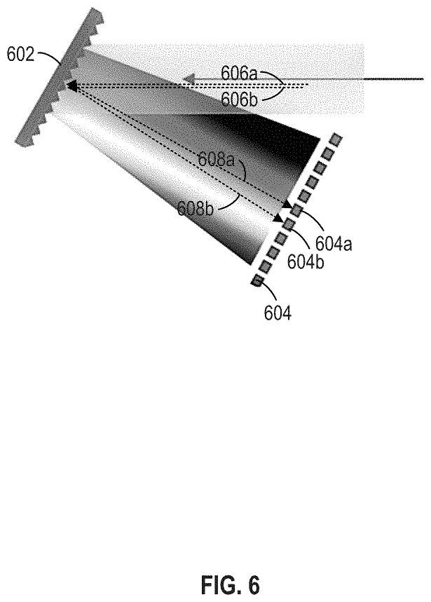

FIG. 2 illustrates a block diagram of an exemplary LiDAR system containing a Littrow configuration external cavity diode laser component, according to embodiments of the disclosure. In some embodiments, LiDAR system 102 may be a bi-axial LiDAR, a coaxial LiDAR, etc. As illustrated, LiDAR system 102 may include a transmitter 202, a receiver 204, and a controller 206 coupled to transmitter 202 and receiver 204. Transmitter 202 may further include a laser diode 208 for emitting laser beams and one or more optics 210 for collimating the emitted laser beams. In some embodiments, transmitter 202 may additionally include a diffraction grating unit 212 that is configured to tune the wavelength and beam pointing of the emitted laser beams. In some embodiments, laser diode 208, optics 210, and diffraction grating unit 212 may be configured according to a Littrow configuration, as further described in more detail in FIGS. 3-4B. Receiver 204 may further include a receiving lens 216, a photodetector 218, and a readout circuit 220. In some embodiments, receiver 204 may further include a diffraction grating unit (not shown), and the photodetector 218 may include a sensor array, as further described in more detail in FIG. 6.

Transmitter 202 may emit optical beams (e.g., pulsed laser beams, continuous wave (CW) beams, frequency modulated continuous wave (FMCW) beams) along multiple directions. According to one example, transmitter 202 may sequentially emit a stream of laser beams with varying wavelengths during a scanning process.

Laser diode 208 may be a semiconductor chip configured to emit laser beams to optics 210. For instance, laser diode 208 may generate laser beams in the ultraviolet, visible, or near-infrared wavelength range, and provide the generated laser beams to optics 210. In some embodiments of the disclosure, depending on underlying laser technology used for generating laser beams, laser diode 208 may include one or more of a double heterostructure (DH) laser emitter, a quantum well laser emitter, a quantum cascade laser emitter, an interband cascade (ICL) laser emitter, a separate confinement heterostructure (SCH) laser emitter, a distributed Bragg reflector (DBR) laser emitter, a distributed feedback (DFB) laser emitter, a vertical-cavity surface-emitting laser (VCSEL) emitter, a vertical-external-cavity surface-emitting laser (VECSEL) emitter, an external-cavity diode laser emitter, etc., or any combination thereof. Depending on the number of laser emitting units in a package, laser diode 208 may include a single emitter containing a single light-emitting unit, a multi-emitter unit containing multiple single emitters packaged in a single chip, an emitter array or laser diode bar containing multiple (e.g., 10, 20, 30, 40, 50, etc.) single emitters in a single substrate, an emitter stack containing multiple laser diode bars or emitter arrays vertically and/or horizontally built up in a single package, etc., or any combination thereof. Depending on the operating time, laser diode 208 may include one or more of a pulsed laser diode (PLD), a CW laser diode, a Quasi-CW laser diode, etc., or any combination thereof.

Optics 210 may include optical components (e.g., lenses, mirrors) that can shape the laser light and collimate the laser light into a narrow laser beam to increase the scan resolution and the range to scan object(s) 214. Diffraction grating unit 212 may include various optical elements such as prisms, mirrors, gratings, optical phased array (e.g., liquid crystal-controlled grating), or any combination thereof. Consistent with embodiments of the disclosure, diffraction grating unit 212 in LiDAR system 102 may include a mass platform and a grating structure on the surface of the platform. The grating structure may include a plurality of grating slits aligned on the surface of the mass platform. In some embodiments, diffraction grating unit 212 may additionally include an actuation mechanism, such as a micro-electro-mechanical system (MEMS) actuation mechanism, that controls diffraction grating unit 212 to rotate around one or more rotational axes of diffraction grating unit 212. The rotation of the diffraction grating unit 212 may cause the wavelength of the emitted laser beams to be changed while changing the directions of the emitted laser beams.

Object(s) 214 may be made of a wide range of materials including, for example, non-metallic objects, rocks, rain, chemical compounds, aerosols, clouds, and even single molecules. In some embodiments, at each time point during a scanning process, the rotating diffraction grating unit 212 may direct the emitted laser beams with varying wavelengths towards objects with specific angles in space, as described in more detail in FIGS. 3-7.

Receiver 204 may be configured to detect returned laser beams 213 reflected by object 214. Upon contact, laser beams can be reflected/scattered by object 214 via backscattering. Returned laser beams 213 may be in a same or different direction from emitted laser beams 211. In some embodiments, receiver 204 may collect at least a portion of laser beams returned from object 214 and output signals reflecting the intensity of the returned laser beams.

As illustrated in FIG. 2, receiver 204 may include a receiving lens 216, a photodetector 218, and a readout circuit 220. In some embodiments, receiver 204 may further include a diffraction grating unit (not shown), as further described in more detail in FIG. 6. Receiving lens 216 may be configured to converge and focus a returned laser beam 213 as a focused laser beam 215.

Photodetector 218 may be configured to detect the focused laser beams 215. In some embodiments, photodetector 218 may convert a laser beam 215 into an electrical signal 217 (e.g., a current or a voltage signal). Electrical signal 217 may be an analog signal which is generated when photons are absorbed in a photodiode included in photodetector 218. In some embodiments, photodetector 218 may include a PIN detector, an avalanche photodiode (APD) detector, a single photon avalanche diode (SPAD) detector, a silicon photo multiplier (SiPM) detector, or the like. In some embodiments, photodetector 218 may include a plurality of photosensors or pixels arranged in a one-dimensional, two-dimensional, or even three-dimensional array.

Readout circuit 220 may be configured to integrate, amplify, filter, and/or multiplex signal detected by photodetector 218 and transfer the integrated, amplified, filtered, and/or multiplexed signal 219 onto an output port (e.g., controller 206) for readout. In some embodiments, readout circuit 220 may act as an interface between photodetector 218 and a signal processing unit (e.g., controller 206). Depending on the configurations, readout circuit 220 may include one or more of a transimpedance amplifier (TIA), an analog-to-digital converter (ADC), a time-to-digital converter (TDC), or the like.

Controller 206 may be configured to control transmitter 202 and/or receiver 204 to perform detection/sensing operations. For instance, controller 206 may control diffraction grating unit 212 to rotate according to a certain pattern. In some embodiments, controller 206 may also implement data acquisition and analysis. For instance, controller 206 may collect digitalized signal information from readout circuit 220, determine the distance of object 214 from LiDAR system 102 according to the travel time of laser beams and angular information of the detected points of the object(s) in space, and construct a high-definition map or 3D buildings and city modeling surrounding LiDAR system 102 based on the distance information of object(s) 214 and the angular information of the detected object(s). In some embodiments, controller 206 may control diffraction grating unit 212 to rotate two rotation axes, so as to achieve a 2D scanning of the environment by LiDAR system 102, as further described in detail below.

FIG. 3 illustrates a schematic diagram of an exemplary operation of a LiDAR system containing a Littrow configuration external cavity diode laser component, according to embodiments of the disclosure. As illustrated in FIG. 3, a LiDAR system 102 may include a Littrow configuration external cavity diode laser component 302, which itself contains a laser diode 308, one or more optics 310, and a diffraction grating unit 312. Diffraction grating unit 312 may include a diffraction grating integrated on an MEMS-based platform coupled to a MEMS driver 304 for driving the rotation of the diffraction grating unit. MEMS driver 304 may be further coupled to a controller 306 for providing signal and/or instruction to MEMS driver 304. As illustrated in FIG. 3, LiDAR system 102 may further include one or more receiving optics 316, a receiving diffraction grating unit 317, a sensor array 318, and receiving electronics 320. Optionally, LiDAR system 102 may be a co-axial LiDAR system, and thus Littrow configuration external cavity diode laser component 302 may optionally include a beam splitter 326 that separates emitted laser beams from returning laser beams. In some embodiments, the beam splitter inside of the laser resonator may be a polarization beam splitter in order to ensure low loss of intracavity components. The polarization beamsplitter, however, may cut the returning laser intensity by about half. In some embodiments, LiDAR system 102 may be bi-axial, and thus Littrow configuration external cavity diode laser component 302 does not include a beam splitter, and the returning laser beams may be directly received by receiving optics 316 without passing through a beam splitter in such a LiDAR system.

Littrow configuration external cavity diode laser component 302 may be configured to sequentially emit a series of laser beams 303a . . . 303n that have varying wavelengths along different directions during a scanning process. That is, instead of emitting laser beams with a fixed wavelength, Littrow configuration external cavity diode laser component 302 may emit laser beams with the wavelength that continuously changes. For instance, the wavelength of the laser beams emitted by Littrow configuration external cavity diode laser component 302 may increase unidirectionally within a certain wavelength range at a certain period, decrease unidirectionally within a certain wavelength range within a certain period, increase then decrease, decrease then increase, or may vary according to certain other patterns. In addition, with the changing wavelengths of the emitted laser beams, the directions of these laser beams towards the environment may be also simultaneously changed due to the rotation of diffraction grating unit 312 included in Littrow configuration external cavity diode laser component 302. Specifically details regarding the rotation of the MEMS-actuated diffraction grating unit that synchronizes both the wavelength tuning (e.g., wavelength changing) and the beam pointing (e.g., output directions of laser beams) are further described in more detail with reference to FIGS. 4A and 4B.

FIG. 4A illustrates an example operation of a Littrow configuration external cavity diode laser component, according to embodiments of the disclosure. As illustrated, Littrow configuration external cavity diode laser component 302 may include a laser diode 402 with a coated anti-reflective layer 404, a diffraction grating 406, and a collimation lens 408. The Littrow configuration refers to the relative orientation of physical components such as a laser diode 402, a collimator lens 408, a diffraction grating unit including a diffraction grating 406 and an actuator coupled thereto, various mounts, and other elements included in the laser emitting system (e.g., transmitter 202 in FIG. 2). The purpose of the Littrow configuration is to integrate laser diode 402 into a larger laser resonator, also called “an external cavity.” The external cavity may create an optical feedback loop in which a small amount of the diffracted laser (e.g., the 1^{st} order diffraction from diffraction grating 406) is reflected back into laser diode 402. This optical feedback generated by the Littrow configuration creates the ability to provide slight adjustments to the wavelengths of the diode laser's output to match a desired set point.

Laser diode 402 may be a simple Fabry-Perot laser diode coupled to an external laser resonator. The external laser resonator may introduce certain features and options for the external cavity diode laser. For instance, compared to a standard laser diode, a longer resonator may increase the damping time of the intracavity light and thus allow for lower phase noise and a smaller emission linewidth. An intracavity filter such as diffraction grating 406 may further reduce the linewidth. It should be noted that the length of the external laser resonator, or the distance between laser diode 402 and diffraction grating 406, may be within a certain range to achieve an optimized performance of the Littrow configuration. Accordingly, diffraction grating 406 may be disposed at a predefined distance from laser diode 402 according to the Littrow configuration.

Anti-reflective layer 404 may be a dielectric thin-film coating applied to the laser diode surface, to reduce the reflectance or reflectivity of the surface due to the Fresnel reflections at least in certain wavelengths. In the anti-reflective layer, the reflected waves from different optical interfaces may cancel each other by destructive interference, so as to reduce the reflectivity of the surface. In some embodiments, anti-reflective layer 404 may be a single-layer anti-reflective coating that includes an anti-reflection thin-film coating designed for normal incidence and comprising a single quarter-wave layer of a material with the refractive index close to the geometric mean value of the refractive indices of two adjacent media. In that situation, two reflections of equal magnitude arise at the two interfaces, and they cancel each other by destructive interference. In some embodiments, multiple layers of anti-reflection thin-film coating may be also possible and are contemplated by the present disclosure.

Collimation lens 408 may be configured to shape laser beams emitted by laser diode 402. After the laser beams highly diverge after leaving the location of semiconductor laser diode 402. The laser beams may be then collimated by collimation lens 408 to create a more uniform beam. The distance between collimation lens 408 and laser diode 402 is determined by the focal length of the lens that is being used. In some embodiments, collimation lens 408 may include a couple of different lenses, e.g., a fast-axis collimation lens and a slow-axis collimation lens, each of which is configured to collimate the divergent laser beams along one axis.

Diffraction grating 406 may be configured to split incoming laser beams into different wavelengths. According to one embodiment, a proper diffraction grating for the Littrow configuration may be chosen by using the following equation:

2 sin θ=λ/d

where d is the grating line spacing (e.g., the distance between lines on diffraction grating 406), θ is the angle between the normal of the diffraction grating unit and the incident beam, and A is the wavelength of the laser output. In some embodiments, the angle θ is close to 45° so that the 0^{th} order diffraction will reflect directly off the diffraction grating unit at a convenient angle of 90°. Accordingly, the rotation of diffraction grating 406 may be limited to a certain range, e.g., with θ being 90°±5°, 90°±10°, 90°±15°, etc.

According to the above equation, when the grating line spacing dis determined, by changing the angle θ between the normal of the diffraction grating unit and the incident beam, the wavelength λ of the laser output can be changed accordingly. In some embodiments, angle θ can be changed by rotating diffraction grating 406 using its coupled actuator. For example, the rotation of diffraction grating 406 may be controlled by applying a voltage to the MEMS actuator (not shown in FIG. 4A) coupled to the diffraction grating 406. For instance, by rotating the diffraction grating unit by Δθ, the angle θ between the normal of the diffraction grating unit and the incident beam is changed by Δθ, the output beam deflects by 2Δθ. The wavelength λ then changes to λ sin(θ+Δθ)/sin θ. That is, by rotating the diffraction grating unit, both the output beam direction and the output beam wavelength can be changed simultaneously. The rotation of diffraction grating 406 allows a particular diffracted wavelength (1^{st} order diffraction) to be fed back into laser diode 402. The actual wavelength of the laser output may thus be determined by combining the gain bandwidth of the laser diode, and the grating dispersion (e.g., grating line spacing).

In some embodiments, the Littrow configuration external cavity diode laser component as described above has certain advantages. For instance, it allows continuous tuning across a bandwidth range, narrow line widths, high stability, low noise, relatively high output power, insensitive to environmental changes. These advantages make it proper in LiDAR applications in navigation, 3D mapping, territorial survey, etc.

In some embodiments, the disclosed Littrow configuration external cavity diode laser component may have other configurations. For example, FIG. 4B illustrates an example operation of another Littrow configuration external cavity diode laser component, according to embodiments of the present disclosure. Similar to the Littrow configuration external cavity diode laser component illustrated in FIG. 4A, the Littrow configuration external cavity diode laser component illustrated in FIG. 4B also includes a laser diode 402 with a coated anti-reflective layer 404, and a collimation lens 408 already illustrated in FIG. 4A. Different from the configuration in FIG. 4A, FIG. 4B uses two separate components, a diffraction grating 406 and a reflection mirror 410, to form the diffraction grating unit. Diffraction grating 406 in this configuration is stationary and not rotating. Instead, the included reflection mirror 410 may be controlled to rotate, driven by the MEMS actuator, to replace the rotation of diffraction grating 406 illustrated in FIG. 4A. That is, instead of rotating a diffraction grating, the reflection mirror in FIG. 4B is configured to rotate to tune the wavelengths and directions of the laser beams emitted by the Littrow configuration external cavity diode laser component.

The Littrow configuration external cavity diode laser component illustrated in FIG. 4B has certain advantages. For instance, keeping the complicated diffraction grating stationary during a scanning process may extend the life span of the diffraction grating in a LiDAR system. In addition, it can be challenging to integrate a diffraction grating into a MEMS actuator-based platform than integrating a reflection mirror into such a platform. Additionally, since the diffraction grating is not required to rotate, it may increase the flexibility to design diffraction grating units with a wide range of varieties (with increased complexity), or it is more convenient to update an existing Littrow configuration external cavity diode laser component by just replacing the diffraction grating element without requiring changing other elements of the existing Littrow configuration external cavity diode laser component. Further, since the emitted laser beams are reflected twice before being emitted out of the laser component, the rotation of the reflection mirror just needs to rotate half of the rotation required by the rotation of the diffraction grating unit illustrated in FIG. 4A if the same angular range of output laser beams is expected. This then further increases the stability of the whole Littrow configuration external cavity diode laser component due to the decreased motion required for reflection mirror 410.

It is to be noted that the Littrow configuration external cavity diode laser components illustrated in FIGS. 4A and 4B are merely for illustrative purposes, but not for limitation. The disclosed LiDAR system may include other configurations of external cavity diode laser suitable for emitting lasers with varying wavelengths under different directions. For instance, a transmission grating, a prism or other spectrally dispersive optical components, or other adjustable optical bandpass filters may be used to replace diffraction grating units in an external cavity diode laser in FIGS. 4A and 4B to achieve similar effects.

Referring back to FIG. 3, after laser beams with varying wavelengths and varying directions are emitted by a Littrow configuration external cavity diode laser component, these laser beams may be directed towards objects 314 in the environment. For instance, a series of laser beams 303a . . . 303n may be sequentially directed towards object 314 at different moments. The laser beams 303a . . . 303n towards object 314 at different angular points may have different wavelengths. For instance, the rotation of diffraction grating unit 312 may cause the emitted laser beam 303n to have a larger wavelength than 303n−1, and so on. Once these laser beams are reflected back to the LiDAR system, these laser beams (e.g., laser beams 305a . . . 305n) also have different wavelengths. That is, returning laser beams 305a . . . 305n reflected from different points of object 314 may also have different wavelengths. In some embodiments, since the angular positions of the emitted laser beams are predetermined (e.g., based on the rotation pattern of the diffraction grating unit in FIG. 4A or reflection mirror in FIG. 4B), the wavelengths of the laser beams reflected from different points of objects are also determined. Accordingly, based on the wavelength information of the returned laser beams, the angular information of the detected object can be easily determined, which then provides an additional dimension of information in constructing a map based on the obtained information.

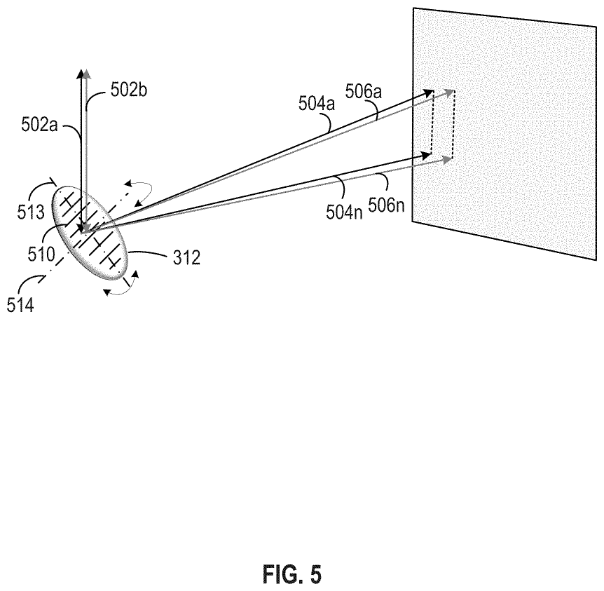

It is to be noted that emitted laser beams 303a . . . 303n caused by the rotation of diffraction grating unit 312 in FIG. 3 merely represent one-dimensional scanning or detection of object 314 in the environment. In real applications, it may be necessary to have a two-dimensional (2D) scanning or range detection of the objects included in the environment. Depending on the configuration of the MEMS actuator that is coupled to and rotates the diffraction grating unit 312 in FIG. 3 (or diffraction grating 406 in FIG. 4A) or the reflection mirror 410 in FIG. 4B, different rotation patterns may be employed to rotate the diffraction grating unit or the reflection mirror, to achieve a 2D scanning or range detection, as further described in more detail in FIG. 5.

FIG. 5 illustrates an example 2D scanning pattern achieved by a Littrow configuration external cavity diode laser component, according to embodiments of the disclosure. For ease of interpretation, only diffraction grating unit 312 of the Littrow configuration external cavity diode laser component is illustrated in the figure. As illustrated, the surface of diffraction grating unit 312 may include a grating pattern with repeated grating structures (e.g., spaced grating lines) 510 aligned along a first direction. In addition, diffraction grating unit 312 may have a first rotation axis 513 that is perpendicular to the direction of the aligned grating structures and a second rotation axis 514 that is in parallel with the aligned grating structures. Given this illustrated arrangement, the angular range for second rotation axis 514 may be broader than that for first rotation axis 513.

In some embodiments, the MEMS actuator (not shown) may control diffraction grating unit 312 to rotate along one axis at any given moment. For instance, during a first period, diffraction grating unit 312 may be controlled to rotate along rotation axis 514. Such rotation of diffraction grating unit 312 may cause the incident angle of laser beams to change, which thus causes the emitted laser beams to change the wavelength (and apparently the directions, too). For instance, for a series of laser beams 502a, the rotation of diffraction grating unit 312 along rotation axis 514 may cause laser beams to scan the environment along a first dimension, e.g., along a vertical dimension as shown by a series of laser beams 504a . . . 504n in FIG. 5 (although only two laser beams 504a and 504n are shown in the figure). In addition, these laser beams 504a . . . 504n may have different wavelengths caused by the rotation of diffraction grating unit 312.

After diffraction grating unit 312 finishes one rotation around rotation axis 514, the MEMS actuator coupled to diffraction grating unit 312 may control diffraction grating unit 312 to rotate around the other rotation axis, e.g., rotation axis 513. That is, the diffraction grating unit 312 may be controlled to also scan along a second dimension (e.g., a horizontal dimension shown in FIG. 5) perpendicular to the first dimension, thereby achieving a 2D scanning or range detection. It is to be noted, when diffraction grating unit 312 is controlled to rotate around rotation axis 513, the wavelength of the emitted laser beam does not necessarily change. For instance, emitted laser beam 506n in FIG. 5 may have a same wavelength as emitted laser beam 504n. After diffraction grating unit 312 is controlled to rotate along rotation axis 513 to a new position along the second dimension, diffraction grating unit 312 may be controlled to rotate around rotation axis 514 again, to scan the environment along the first dimension. For instance, for a series of incident laser beams 502b, during a second period, the emitted laser beams may sequentially scan the environment from 506n to 506a, with the changing wavelengths of the emitted laser beams during the scanning process. These emitted laser beams 504a . . . 504n and 506n . . . 506a with varying wavelengths may be then reflected back by the object(s) in the environment during the scanning process and are further detected.

Referring back to FIG. 3, during a certain period of a scanning process, a series of laser beams 305a . . . 305n with varying wavelengths may be returned from object 314. For a bi-axial LiDAR system, the returned laser beams may be directed towards the receiver of the LiDAR system, such as the receiving lens of the LiDAR system as further described in detail below. However, for a co-axial LiDAR system, the returning laser beams 305a . . . 305n may pass through a beam splitter that separates returning laser beams from the emitting laser beams. In some embodiments, the beam splitter may be also located within the external cavity, as beam splitter 326 shown in FIG. 3.

The returning laser beams (e.g., laser beams 309a . . . 309n) with or without passing through beam splitter 326 may be received by receiving optics 316. These laser beams 309a . . . 309n may have varying wavelengths. Receiving optics 316 may converge and focus a returned laser beam 309a or 309n as a focused laser beam, which may be directed to a receiving diffraction grating unit 317. The receiving diffraction grating unit 317 may direct the returning laser beams with different wavelengths toward different parts of sensor array 318 for signal detection, as further described in more detail in FIG. 6.

FIG. 6 illustrates an exemplary detection of returning laser beams with varying wavelengths by a detector with a diffraction grating unit and a sensor array, according to embodiments of the disclosure. As illustrated, the receiving end of the disclosed LiDAR system 102 may include a diffraction grating unit 602 (also referred to as “receiving diffraction grating unit” or “second diffraction grating unit” to differentiate it from the diffraction grating unit included in the Littrow configuration external cavity diode laser component) and a sensor array 604. Receiving diffraction grating unit 602 may include a grating structure that directs returning laser beams towards different directions, although the incident angles of returning laser beams are similar to each other. For instance, for two different returning laser beams 606a and 606b, they may have different wavelengths due to the varying wavelengths of the laser beams emitted by the Littrow configuration external cavity diode laser component. The two returning laser beams 606a and 606b, when being incident on diffraction grating unit 602, may be directed towards different directions due to the difference in wavelength and due to the grating structure on diffraction grating unit 602. For instance, for returning laser beam 606a with a wavelength λ1, diffraction grating unit 602 may direct it towards sensor unit 604a in sensor array 604. For returning laser beam 606b with a different wavelength λ2, diffraction grating unit 602 may direct it towards sensor unit 604b in sensor array 604. Accordingly, for sensor array 604, each included sensor unit 604n may just cover one portion of the wavelength range emitted by the Littrow configuration external cavity diode laser component, or just cover certain angular directions in space due to the correspondence between the angular points in space and the wavelengths. The more the sensor units, the higher accuracy for detecting laser beams with varying wavelengths or angular points within a certain space range.

It is to be noted that, since each sensor unit covers only a certain wavelength or a certain range of wavelengths, the wavelengths that are not within such a range will not be directed to that sensor unit, and thus will not be detected by that sensor unit. Accordingly, by the signal collected from each sensor unit has reduced ambient noise, since the ambient light may have little contribution within the wavelength range of that sensor unit.

In some embodiments, different approaches may be employed to collect signals from a specific sensor unit 604n in sensor array 604. In one example, the sensor units included in the sensor array may be controlled to open only one at each time point, so that only the sensor unit corresponding to the wavelength of the returning laser beam is controlled to open, while other sensor units are controlled to be closed or inactive so that no signals will be collected by these sensor units. In another example, all sensor units may remain open or active at any moment. However, the signal processing process may only select a sensor unit that has the strongest signal for further processing but ignore much weaker signals collected from other sensor units. It is to be noted that other approaches for collecting signals from a specific sensor unit are also possible and are contemplated by the disclosure.

Referring back to FIG. 3, after the signal detection by sensor array 318, the detected signals may be further processed by receiving electronics 320 and/or by controller 306. In some embodiments, receiving electronics 320 may include one or more components that are configured to convert detected optical signals into digital signals that can be further processed by controller 306, such as the construction of a high-definition map or three-dimensional (3D) buildings and city modeling. In some embodiments, receiving electronics 320 may have similar functions as readout circuit 220, or may include similar components as readout circuit 220 as illustrated in FIG. 2, details of which are not repeated here.

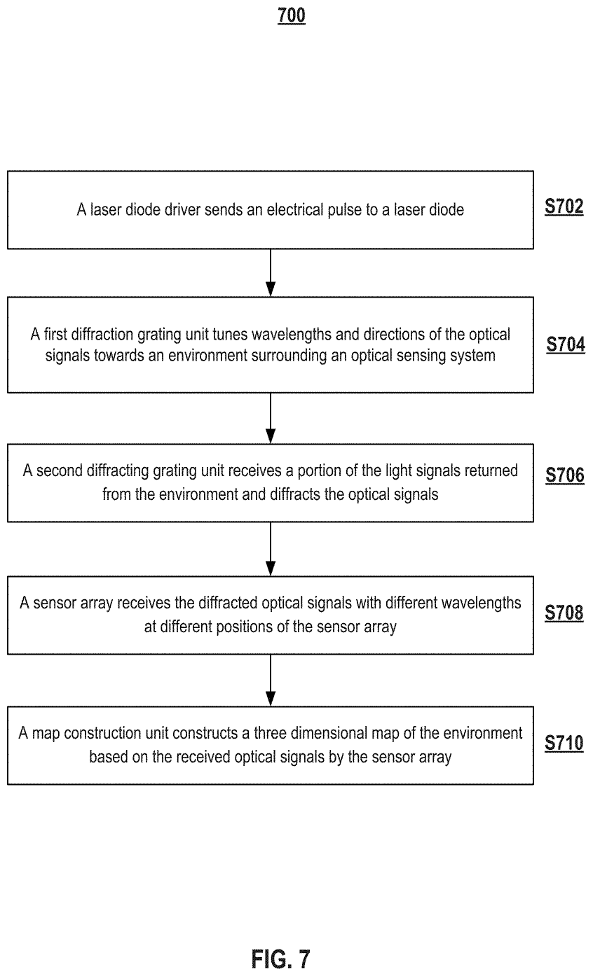

In some embodiments, controller 306 may include a processing unit configured to construct a 3D map based on the detected signals from the environment. In some embodiments, during the signal processing process, controller 306 may map signals from each sensor unit to an angular direction towards a point in the space in the environment, which may reduce certain computation (e.g., matching signals from different scanning frames) in the data processing. In addition, since each signal may not just contain the position information in space but also contain angular information (e.g., at which angle a laser beam hits that position or that point), additional dimension or layer of information may be extracted from these signals, which thus facilitates the construction of a high-definition map or three-dimensional (3D) buildings and city modeling, and/or improves the accuracy in such processes. One example application of the above-described LiDAR system 102 in environmental sensing will be described further below in FIG. 7.

FIG. 7 is a flow chart of an exemplary optical sensing method 700 performed by an optical sensing system (e.g., a LiDAR system 102) according to embodiments of the disclosure. In some embodiments, method 700 may be performed by various components of LiDAR system 102, e.g., a Littrow configuration external cavity diode laser component, a receiving diffraction grating unit, and a sensor array. In some embodiments, method 700 may include steps S702-S710. It is to be appreciated that some of the steps may be optional. Further, some of the steps may be performed simultaneously, or in a different order than that shown in FIG. 7.

In step S702, a laser diode driver sends an electrical pulse to the laser diode for it to emit optical signals. Here, the laser diode may be a semiconductor chip that is a part of a Littrow configuration external cavity diode laser component included in an optical sensing system. For instance, the laser diode may be coupled to a resonator, also called “an external cavity.” The external cavity may create an optical feedback loop in which a small amount of the laser output (e.g., the 1^{st} order diffraction) is reflected back into the laser diode from the diffraction grating unit located at the other end of the external cavity. This optical feedback generated by the Littrow configuration creates the ability to provide slight adjustments to the wavelengths of the diode laser's output to match a desired set point.

In step S704, a first diffraction grating unit determines the wavelengths and directions of the optical signals towards an environment surrounding the optical sensing system. Here, the tuning of the wavelengths and directions of the emitted optical signals are controlled by the rotation of a diffraction grating unit, which is an element of the Littrow configuration external cavity diode laser component, and may be referred to as the first diffraction grating unit. According to the Littrow configuration, the 1^{st} order diffraction by the first diffraction grating unit may be reflected back to the laser diode, and the 0^{th} order diffraction may be directed towards the environment, although another order (e.g. −1^{st} order) of diffraction may be directed towards the environment. In some embodiments, the rotation of the first diffraction grating unit (or the reflection mirror described in FIG. 4B) may cause both the wavelength and the output direction of the emitted laser beams to change. That is, the rotation of the first diffraction grating unit (or the reflection mirror) may tune the wavelengths and directions or angular directions of the optical signals towards the environment surrounding the optical sensing system. In some embodiments, the wavelength and the angular direction of an emitted optical signal have a correspondence relationship. That is, an emitted optical signal has a predefined wavelength when emitting at a specific angular direction towards the environment.

In step S706, a second diffracting grating unit receives a portion of the light signals returned from the environment and diffracts the received optical signals along certain directions. In some embodiments, after the optical signals with varying wavelengths are directed towards the environment, at least a portion of the optical signals may be returned back to the optical sensing system from the environment. The returning optical signals may be focused or converged, by a receiving lens, to a diffraction grating unit included in the receiving end of the optical sensing system. Here, the diffraction grating unit may be referred to as the second diffraction grating unit or as a receiving diffraction grating unit. The second diffraction grating unit may diffract the received optical signals having different wavelengths at different directions towards the sensors (e.g., a sensor array) included in the receiving end of the optical sensing system.

In step S708, a sensor array receives the diffracted optical signals with different wavelengths at different positions of the sensor array. The sensor array may include a plurality of sensor units organized in an array. Each sensor unit included in the array may only detect diffracted optical signals with a certain wavelength or within a certain wavelength range. Any optical signals outside the range will not be detected by that sensor unit, which may facilitate filtering out ambient noise during the signal detection process. In addition, since the returning optical signals have varying wavelengths that change according to a certain pattern, the diffracted optical signals may also follow a certain pattern when being detected by the sensor unit included in the sensor array (e.g., sensor units sequentially detect diffracted optical signals). In some embodiments, the sensor units included in the array may be activated (controlled to be active or to open) according to a predefined pattern that matches the pattern of the varying wavelengths of the returning laser beams.

In step S710, a map construction unit constructs a three-dimensional map of the environment based on the received optical signals by the sensor array. Here, the map construction unit may be part of the optical sensing system, or may be a separate part remotely located. The map construction unit may construct the map according to the detection range of the scene. Each signal returning from that covered range may be separately processed and integrated into the construction of the 3D map. In some embodiments, since each detected signal may correspond to a certain wavelength, which itself further corresponds to an angular direction that a laser beam hits the objects in the environment, an additional dimension of information (e.g., angular directions) may be used to construct the 3D map. For instance, the map construction unit may acquire a wavelength of each received optical signal, determine angular information of a corresponding emitted optical signal, and construct the 3D map of the environment also based on the angular information corresponding to each received optical signal (beyond the location information of the detected object(s)). In some embodiments, the accuracy of constructed 3D map may be increased when due to the incorporation of angular information in constructing the map. It is contemplated that map construction is just one exemplary use of the optical signal sensed in steps S702-S708, and other applications, such as locating a vehicle, positioning an object in the environment, etc., are possible.

Although the disclosure is made using a LiDAR system as an example, the disclosed embodiments may be adapted and implemented to other types of optical sensing systems that use receivers to receive optical signals not limited to laser beams. For example, the embodiments may be readily adapted for optical imaging systems or radar detection systems that use electromagnetic waves to scan objects.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. An optical sensing system, comprising:
an integrated optical source, wherein the integrated optical source comprises a laser diode configured to emit optical signals and a first diffraction grating unit configured to simultaneously tune wavelengths and directions of the emitted optical signals, wherein the optical signals of different wavelengths are directed along different directions towards an environment surrounding the optical sensing system; and
a receiver, configured to receive at least a portion of the optical signals returned from the environment, wherein the receiver comprises a second diffracting grating unit configured to direct the received portion of optical signals with the different wavelengths along different directions towards a sensor array, the sensor array is configured to receive the optical signals of the different wavelengths at different positions of the sensor array.

2. The optical sensing system of claim 1, wherein the first diffraction grating unit comprises a diffraction grating mounted on a micro-electro-mechanical system (MEMS)-based actuator, wherein the MEMS-based actuator is configured to rotate the first diffraction grating unit in order to tune the wavelengths and directions of the emitted optical signals.

3. The optical sensing system of claim 1, wherein the first diffraction grating unit comprises a diffraction grating and a MEMS mirror, wherein the MEMS mirror is configured to rotate and reflect the optical signals emitted by the laser diode to the diffraction grating at a set of directions, wherein the diffraction grating is configured to tune wavelengths of the reflected optical signals to the different wavelengths and direct the reflected optical signals to the different directions.

4. The optical sensing system of claim 1, wherein the first diffraction grating unit comprises a surface grating structure with a predefined diffraction grating pattern.

5. The optical sensing system of claim 1, wherein the first diffraction grating unit is positioned at a predefined distance from the laser diode.

6. The optical sensing system of claim 1, wherein the first diffraction grating unit is positioned to direct first-order diffracted light beams to return to the laser diode and zeroth order diffracted light beams towards the environment surrounding the optical sensing system.

7. The optical sensing system of claim 1, wherein each sensor in the sensor array is configured to detect optical signals of a predetermined spectral range.

8. The optical sensing system of claim 1, wherein each sensor in the sensor array is configured to receive optical signals within a predetermined range of angular directions in space.

9. The optical sensing system of claim 1, wherein the laser diode and the first diffraction grating unit are located in a same cavity to form an external cavity laser diode.

10. The optical sensing system of claim 1, further comprising a processor configured to construct a three-dimensional map of the environment based on the portion of optical signals received by the sensor array.

11. An optical sensing method performed by an optical sensing system, comprising:
emitting, by a laser diode, optical signals;
tuning, by a first diffraction grating unit, wavelengths and directions of the optical signals towards an environment surrounding the optical sensing system;
receiving, by a second diffraction grating unit, a portion of the optical signals returned from the environment, wherein the received optical signals are diffracted towards different directions by the second diffraction grating unit; and
receiving, by a sensor array, the diffracted optical signals with different wavelengths at different positions of the sensor array.

12. The optical sensing method of claim 11, wherein tuning the wavelengths and directions of the optical signals comprises:
rotating the first diffraction grating unit according to a predefined pattern, wherein the rotation of the first diffraction grating unit causes a simultaneous change of a wavelength and an angular direction of an emitted optical signal towards the environment.

13. The optical sensing method of claim 12, wherein the wavelength and the angular direction of an emitted optical signal have a correspondence relationship.

14. The optical sensing method of claim 13, further comprising constructing a three-dimensional map of the environment based on the received optical signals by the sensor array.

15. The optical sensing method of claim 14, wherein constructing a three-dimensional map of the environment based on the received optical signals further comprises:
acquiring a wavelength of each received optical signal;
determining angular direction of a corresponding wavelength of the optical signal; and
construct the three-dimensional map of the environment based on the angular direction corresponding to each received optical signal.

16. The optical sensing method of claim 11, wherein each sensor in the sensor array is configured to detect optical signals of a predetermined spectral range.

17. The optical sensing method of claim 11, wherein receiving the diffracted optical signals with different wavelengths at different positions of the sensor array further comprises:
sequentially activating sensor units therein included in the sensor array according to a predefined pattern; and
receiving the diffracted optical signals by the sequentially activated sensor units included in the sensor array.

18. The optical sensing method of claim 11, wherein the first diffraction grating unit comprises a diffraction grating mounted on a micro-electro-mechanical system (MEMS)-based actuator, wherein tuning wavelengths and directions of the optical signals towards an environment surrounding the optical sensing system further comprises:
rotating, by the MEMS-based actuator, the first diffraction grating unit.

19. The optical sensing method of claim 11, wherein the first diffraction grating unit comprises a diffraction grating and a MEMS mirror, wherein tuning wavelengths and directions of the optical signals towards an environment surrounding the optical sensing system further comprises:
rotating the MEMS mirror to reflect the optical signals emitted by the laser diode to the diffraction grating at a set of directions; and
tuning wavelengths of the reflected optical signals, the diffraction grating, to different wavelengths and direct the reflected optical signals to different directions.

20. An integrated optical source, comprising:
a laser diode configured to emit optical signals; and
a diffraction grating unit configured to simultaneously tune wavelengths and directions of the emitted optical signals,
wherein the optical signals of different wavelengths are directed along different directions towards an environment surrounding the integrated optical source.
